(19) United States
(12) Patent Application Publication
(10) Pub. No.: US 2013/0180582 A1
(43) Pub. Date: Jul. 18, 2013

(54) DYE SENSITIZED SOLAR CELL

(71) Applicant: MKE Technologies Co., LTD, Taipei City (TW)

(72) Inventors: Wei-Lun HSU, Taipei City (TW); Chien-Tung TENG, Taipei City (TW); Kuang-Feng CHUNG, Taipei City (TW)

(73) Assignee: MKE TECHNOLOGIES CO. LTD, Taipei City (TW)

(21) Appl. No.: 13/733,636

(22) Filed: Jan. 3, 2013

(30) Foreign Application Priority Data
Jan. 17, 2012 (TW) 101101764

(51) Int. Cl. H01G 9/20

(52) U.S. Cl. CPC H01G 9/2022
USPC 136/256

(57) ABSTRACT

A dye sensitized solar cell includes a first conducting substrate, a dye layer, a first conducting layer and a second conducting substrate. The dye layer has at least one dye portion and is disposed on the first conducting substrate. The first conducting layer is disposed on the first conducting substrate and around the dye portion, and is formed into at least one hexagon. The second conducting substrate is disposed opposite to the first conducting substrate.

### CROSS REFERENCE TO RELATED APPLICATIONS

This Non-provisional application claims priority under 35 U.S.C. §119(a) on Patent Application No(s). 101101764 filed in Taiwan, Republic of China on Jan. 17, 2012, the entire contents of which are hereby incorporated by reference.

### BACKGROUND OF THE INVENTION

1. Field of Invention

The invention relates to a solar cell and, in particular, to a dye sensitized solar cell.

2. Related Art

Solar energy does not cause environmental pollution and is easily acquired and never exhausted, becoming an important resource of alternative energy. The solar cell utilizing solar energy is a kind of photoelectric converting device, which can receive solar light and convert solar energy to electric energy.

The solar cell has many varieties, such as silicon-based solar cell, compound semiconductor solar cell, organic solar cell, or dye sensitized solar cell (DSSC). As to the DSSC, it includes two conducting substrates attached to each other in structure. One of the conducting substrate has titanium dioxide (TiO2) thereon, which absorbs the dye to become a dye layer, and the other one has a catalytic layer, such as platinum (Pt), thereon. The area of the dye layer is a very important factor of affecting the photoelectric converting efficiency of the solar cell.

Therefore, it is an important subject to provide a dye sensitized solar cell that is improved in structure to enhance the photoelectric converting efficiency.

### SUMMARY OF THE INVENTION

In view of the foregoing subject, an objective of the invention is to provide a dye sensitized solar cell that can enhance the photoelectric converting efficiency.

To achieve the above objective, a dye sensitized solar cell of the invention includes a first conducting substrate, a dye layer, a first conducting layer and a second conducting substrate. The dye layer has at least one dye portion and is disposed on the first conducting substrate. The first conducting layer is disposed on the first conducting substrate and around the dye portion, and is formed into at least one hexagon. The second conducting substrate is disposed opposite to the first conducting substrate.

In one embodiment, the dye portion is formed into a hexagon.

In one embodiment, the first conducting layer has a plurality of hexagons.

In one embodiment, at least one hexagon formed by the first conducting layer has an area that is not less than the area of the hexagon formed by the dye portion.

In one embodiment, a distance between the first conducting layer and the dye portion is between 0.1 mm and 50 mm.

In one embodiment, the dye sensitized solar cell further comprises an insulating protective layer disposed on the first conducting layer. The material of the insulating protective layer can include glass paste, such as bismuth oxide.

In one embodiment, the dye sensitized solar cell further comprises a second conducting layer disposed on the second conducting substrate.

In one embodiment, the line width of the first conducting layer or the second conducting layer is between 0.1 mm and 30 mm.

In one embodiment, the first conducting layer and the second conducting layer are aligned with each other.

As mentioned above, in the dye sensitized solar cell of the invention, the first conducting layer is disposed around the dye portion, and formed into at least one hexagon, thereby causing a close-packed structure. Therefore, the electrons generated by the dye portion disposed within the hexagon can be transmitted through the conducting substrate in a shortest route to the first conducting layer, thereby improving the photoelectric converting efficiency.

### BRIEF DESCRIPTION OF THE DRAWINGS

The invention will become more fully understood from the detailed description and accompanying drawings, which are given for illustration only, and thus are not limitative of the present invention, and wherein:

FIGS. 1 and 3 are schematic diagram of different dye sensitized solar cells of a preferred embodiment of the invention;

FIG. 2 is a schematic top view of the dye layer and the first conducting layer of the dye sensitized solar cell of the preferred embodiment of the invention;

FIG. 4 is a schematic diagram of an equilateral hexagon inscribed in a circle;

FIGS. 5A and 5B are schematic diagrams showing titanium dioxide as the dye-absorbing layer disposed on the first conducting substrate;

FIGS. 6A and 6B are schematic diagrams showing the dye portions in three different forms (hexagon, square, rectangle) and the electron transport routes of the first conducting layer;

FIG. 7A is a schematic top view of the first conducting layer of the dye sensitized solar cell of another embodiment of the invention;

FIG. 7B is a schematic top view of the second conducting layer of the dye sensitized solar cell of another embodiment of the invention;

FIG. 7C is a schematic diagram of the first and second conducting layers as shown in FIGS. 7A and 7B overlapped with each other;

FIG. 8A is a schematic diagram of the first conducting layer, which is formed into hexagons, of the dye sensitized solar cell of another embodiment of the invention;

FIG. 8B is a schematic diagram of the second conducting layer, which is formed into hexagons, of the dye sensitized solar cell of another embodiment of the invention;

FIG. 8C is a schematic diagram of the first and second conducting layers as shown in FIGS. 8A and 8B overlapped with each other;

FIG. 8D is a schematic diagram of a circuit board used to electrically connect the first and second electrode units as shown in FIG. 8C;

FIG. 9A is a schematic diagram of the first conducting layer, which is formed into hexagons, of the dye sensitized solar cell of another embodiment of the invention;

FIG. 9B is a schematic diagram of the second conducting layer, which is formed into hexagons, of the dye sensitized solar cell of another embodiment of the invention;

FIG. 9C is a schematic diagram of the first and second conducting layers as shown in FIGS. 9A and 9B overlapped with each other; and

FIG. 9D is a schematic diagram of a circuit board used to electrically connect the first and second electrode units as shown in FIG. 9C;

### DETAILED DESCRIPTION OF THE INVENTION

The present invention will be apparent from the following detailed description, which proceeds with reference to the accompanying drawings, wherein the same references relate to the same elements.

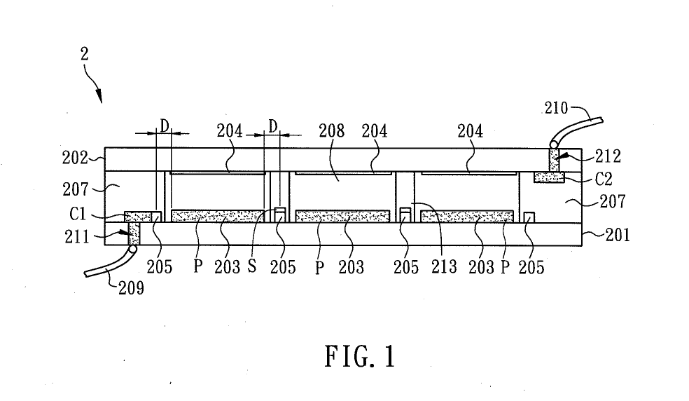

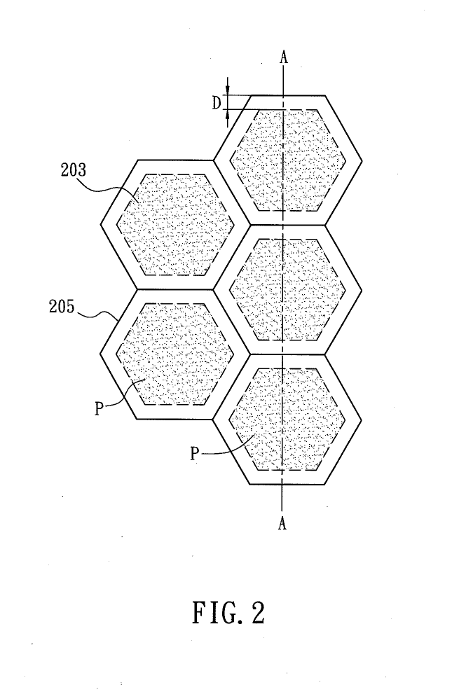

FIG. 1 is a schematic diagram of a dye sensitized solar cell 2 of a preferred embodiment of the invention. The dye sensitized solar cell 2 includes a first conducting substrate 201, a dye layer 203, a first conducting layer 205, and a second conducting substrate 202. FIG. 2 is a schematic top view of the dye layer 203 and the first conducting layer 205, and FIG. 1 is a sectional diagram taken along the line A-A in FIG. 2. Referring to FIGS. 1 and 2, the dye sensitized solar cell 2 is illustrated as below.

The first and second conducing substrates 201 and 202 are not limited in material. Each of them can be, for example, a silicon substrate, a ceramic substrate, a metal substrate, a glass substrate, or a plastic substrate. Herein, the first conducting substrate 201 is transparent so that the sun light can be emitted to the first conducting substrate 201. The second conducting substrate 202 can be transparent or opaque. The first conducting substrate 201 and the second conducting substrate 202 each has a conducting layer, which can be a transparent conducting layer or an opaque conducting layer. The material of the transparent conducting layer can be, for example, transparent conducting oxide (TCO), such as indium oxide tin (ITO), tin oxide, or zinc oxide. The material of the transparent conducting layer also can be tin oxide doped with fluorine (SnO2:F), and this kind of substrate is called an FTO substrate.

The dye layer 203 is disposed on the first conducting substrate 201, and has a plurality of dye portions P, at least one of which is a hexagon. To be noted, the number of the dye portions P of the dye layer 203 as shown in FIS. 1 and 2 is for example, but not for limiting the scope of the invention. A dye-absorbing layer (such as titanium dioxide (TiO2)) can be disposed on the first conducting substrate 201, and then the dye is disposed so that the TiO2 can absorb the dye to form the dye layer 203. When receiving the light, the dye layer 203 will generate electrons, and the electrons can be transmitted to the conducting layers of the conducting substrates 201 and 202. Herein, the dye in the dye layer 203 can include, for example, ruthenium metal complexes pigment, or organic pigment, such as methoxy pigment or phthalocyanine.

The first conducting layer 205 is disposed on the first conducting substrate 201 and around the dye portions P. The first conducting layer 205 is a silver paste for example. Otherwise, it can be an aluminum paste, a copper paste or the like. The first conducting layer 205 can be formed by printing, coating, or paste dispensing. The disposition of the first conducting layer 205 can improve the transmission of the electrons generated by the dye portions P. Hence, the electrons generated by the dye portions P are transmitted to the conducting layer of the first conducting substrate 201, and then transmitted to the first conducting layer 205 through the conducting layer.

The first conducting layer 205 is disposed around the dye layer 203, and formed into at least one hexagon. Herein, the first conducting layer 205 is formed into a plurality of hexagons for example, and each of the hexagon is an equilateral hexagon. At least one of the hexagon formed by the first conducting layer 205 has an area not less than the area of a hexagon formed by a dye portion P. By such a design, the first conducting layer 205 can provide the optimum carrier transport efficiency. Besides, the first conducting layer 205 and the dye layer 203 therein are formed into a honeycomb, sharing mutual sides to become a close-packed structure, so that the dye area and the photoelectric converting efficiency can be enormously enhanced. In the embodiment, the dye layer 203 is also formed into a plurality of hexagons (equilateral hexagons for example), which are respectively disposed within the hexagons formed by the first conducting layer 205. A distance D between the first conducting layer 205 and the dye layer 203 is between 0.1 mm and 50 mm, and preferably between 0.2 mm and 1 mm. According to such features, the power generating efficiency of the embodiment can be improved more effectively. Of course, the distance D can be changed according to the practical requirements.

The dye sensitized solar cell 2 can further include an insulating protective layer S, which is disposed on the first conducting layer 205. The material of the insulating protective layer S can include, for example, glass paste, which can be bismuth oxide, for reducing the oxidation of the first conducting layer 205 and also providing the electrical insulation.

Besides, an electricity-collecting portion C1 (shaped like a strip for example) is disposed at an outermost side of the first conducting layer 205 for collecting the current of the dye sensitized solar cell 2, and can function as an anode or a cathode to electrically connect with the neighboring dye sensitized solar cell or an external control circuit in parallel or in series.

The first conducting substrate 201 can further have a first conducting hole 211 therein, and a first conducting wire 209 is electrically connected with the first conducting substrate 201 through the first conducting hole 211. The first conducting wire 209 can be a printed wire or a cable, and is instanced as being a cable here. The first conducting hole 211 is filled with a conducting solder, and welded so as to electrically connect the first conducting wire 209. Besides, the first conducting hole 211 is electrically connected with the first conducting substrate 201 through the first conducting layer 205. Herein, a portion (electricity-collecting portion C1) of the first conducting layer 205 is directly connected with the first conducting hole 211.

The second conducting substrate 202 is disposed opposite to the first conducting substrate 201. A catalytic layer 204 is disposed on the second conducting substrate 202. The catalytic layer 204 is made by using platinum (Pt) or carbon for example, for improving the oxidation reduction of an electrolyte 208.

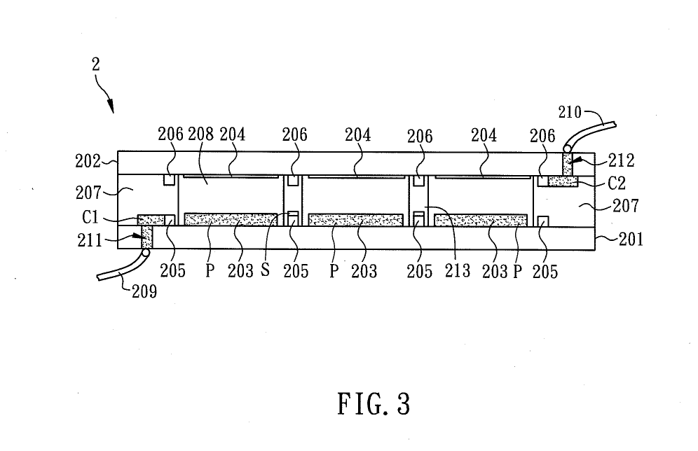

Referring to FIG. 3, the dye sensitized solar cell 2 can further include a second conducting layer 206, which is disposed on the second conducting substrate 202. A second conducting hole 212 is electrically connected with the second conducting substrate 202 through the second conducting layer 206. A portion (an electricity-collecting portion C2) of the second conducting layer 206 is directly connected with the second conducting hole 212, and the other portion of the second conducting layer 206 is disposed around the catalytic layer 204 to be formed into at least one frame portion, which is instanced as a hexagon and especially an equilateral hexagon. Accordingly, the second conducting layer 206 can be aligned with the first conducting layer 205. In the embodiment, the line width of the first conducting layer 205 or the second conducting layer 206 is between 0.1 mm and 30 mm for example, and preferably between 0.2 mm and 1.5 mm. To be noted, the line widths of the first and second conducting layers 205 and 206 can be equivalent or different.

The second conducting layer 206 can improve the transmission of the electrons, and constitute an electrical loop with the first conducting layer 205. An electricity-collecting portion C2 (shaped like a strip for example, and substantially parallel with the electricity-collecting portion C1 of the first conducting layer 205) is disposed at an outermost side of the second conducting layer 206 for collecting the current of the dye sensitized solar cell 2, and can function as an anode or a cathode of the dye sensitized solar cell 2 to electrically connect a neighboring dye sensitized solar cell or an external control circuit in parallel or in series. The second conducting layer 206 is a silver paste for example; otherwise, it can be an aluminum paste, a copper paste or the like. The dye sensitized solar cell 2 can further include an insulating protective layer, which is disposed on the frame portion of the second conducting layer 206. The material of the insulating protective layer can include, for example, glass paste, which can be a bismuth oxide, for reducing the oxidation of the frame portion of the second conducting layer 206 and preventing a short circuit between the second conducting layer 206 and the first conducting layer 205.

Besides, the dye sensitized solar cell 2 can further include a second conducting wire 210, which is electrically connected with the second conducting substrate 202 through the second conducting hole 212. The second conducting wire 210 can be a printed wire or a cable, and is instanced as a cable here. The second conducting hole 212 is filled with a conducting solder, and welded to electrically connect the second conducting wire 210. Besides, the second conducting hole 212 is electrically connected with the second conducting substrate 202 through the second conducting layer 206. Herein, a portion (electricity-collecting portion C2 for example) of the second conducting layer 206 is directly connected with the second conducting hole 212.

The dye sensitized solar cell 2 can further include a sealant 207, which connects the first conducting substrate 201 and the second conducting substrate 202. The first and second conducting substrates 201 and 202 and the sealant 207 constitute a sealed space. The sealant 207 can include a resin material that is waterproof and heat-resistant, for extending the lifetime of the product.

In order to increase the connection strength between the first and second conducting substrates 201 and 202, an adhesive 213 can be disposed between the first and second conducting substrates 201 and 202. Herein, the adhesive 213 is disposed between the first conducting layer 205 and the second conducting layer 206 to connect the first and second conducting substrates 201 and 202. Besides, the sealant 207 and the adhesive 213 can be made by using the same material, such as a hot-melt adhesive, a UV adhesive, or an epoxy resin.

The dye sensitized solar cell 2 can further include an electrolyte 208, which is filled in the sealed space. After being illuminated, the dye molecules in the dye layer 203 are excited to the excited state, rapidly providing electrons to the first conducting substrate 201 or the first conducting layer 205, and then become the oxidation state after providing the electrons. Subsequently, after obtaining the electrons from the electrolyte 208, the dye molecules on the oxidation state come back to the ground state so that the dye molecules are recovered. As to the electrolyte 208 having provided the electrons, it will diffuse to the second conducting substrate 202 or the second conducting layer 206 to get recovered by obtaining the electrons. Accordingly, a photoelectric chemical reaction cycle is completed.

In summary, in the dye sensitized solar cell of the invention, the first conducting layer is disposed around the dye portion, and the first conducting layer and the dye portion are formed into at least one hexagon. Accordingly, there are some advantages as the first conducting layer and the dye portion are formed into hexagon, such as:

1. Less Material Waste and Higher Package Density

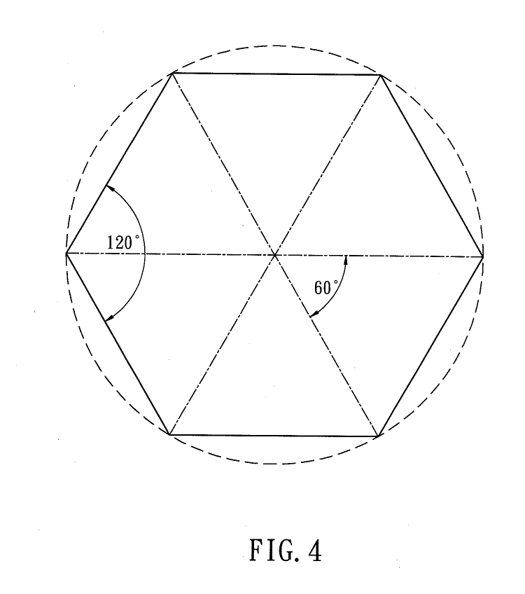

FIG. 4 is a schematic diagram of an equilateral hexagon inscribed in a circle. When an equilateral hexagon is inscribed in a circle, the circle's radius just equals a side of the equilateral hexagon, and the equilateral hexagon's longest diagonal equals the diameter of the circle. Accordingly, the equilateral hexagon can be regarded as an approximate figure of the circle. Among polygons with the same perimeter, an equilateral polygon has the largest area, and the equilateral polygon with more sides has larger area. The area of the circle is larger than any equilateral polygon with the same perimeter as the circle. However, in point of the package, circles can not share sides with each other, but only points are connected when circles are packed together, so the circle's package density is poor and may leave more unused space. By contrast, the equilateral hexagon can make less material waste and a higher package density.

2. Average Stress

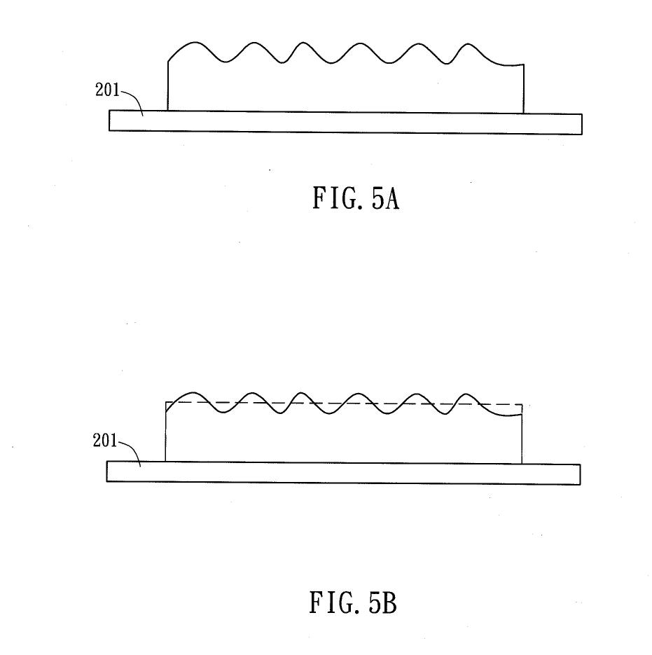

The equilateral hexagon structure is common in chemistry. Subjected to the resonance effect, the structure of a benzene ring is an equilateral hexagon. Graphite has a successive layer structure in which carbon molecules are arranged in equilateral hexagons, and ice crystal is also a hexagon. Besides, when water molecules freeze, they will be attracted by the hydrogen bonds and then become equilateral hexagons in structure, just because the equilateral hexagon is subjected to the average stress. FIGS. 5A and 5B are schematic diagrams showing titanium dioxide as the dye-absorbing layer disposed on the first conducting substrate 201. When the first conducting substrate 201 is coated with the titanium dioxide, the titanium dioxide's surface is rough. The titanium dioxide layer needs to be spread out so as to be leveled. When the titanium dioxide layer is spread out by the gravity, the thickness difference of the titanium dioxide layer will be reduced a lot because of the average stress of the hexagon approximate to a circle, therefore decreasing the variance and enhancing the yield.

3. Enhanced Electron Transport Efficiency

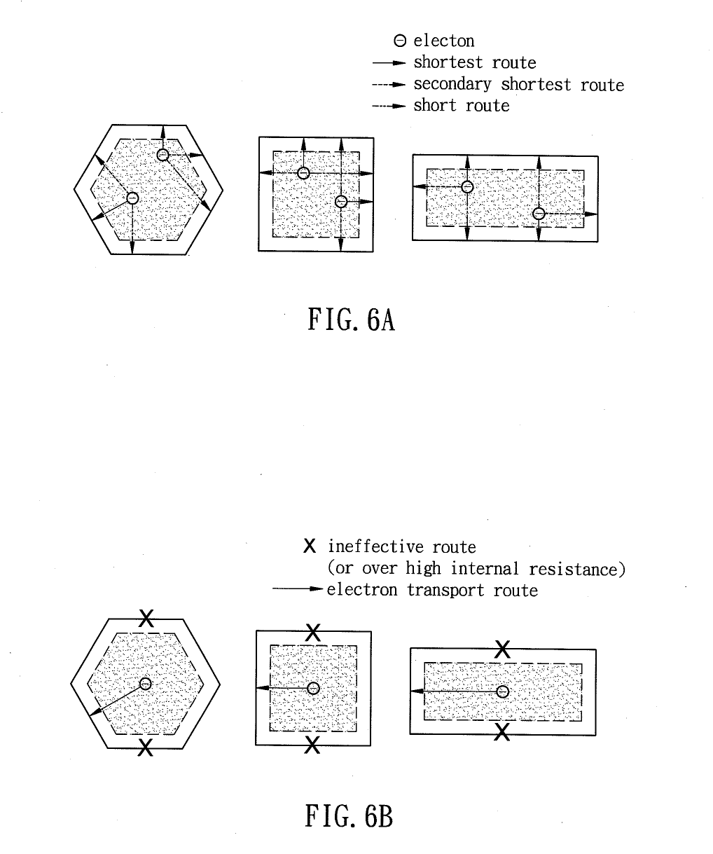

FIG. 6A is a schematic diagram showing the dye portions in the three different forms (hexagon, square, rectangle) and the electron transport routes of the first conducting layer. The electron transport routes can include a shortest route, a secondary shortest route, and a short route. However, actually in the electron's transport, the shortest route will be ineffective due to the over high internal resistance, as shown in FIG. 6B. If the shortest route is ineffective, the travelling distance of the electron will be elongated, thus increasing the internal resistance. However, the regular hexagon has equal distances from its center to each side, so the travelling distance will not be increased when the route therein is ineffective.

In addition, the dye sensitized solar cell 2 can include various aspects related to the series connection or parallel connection, which are illustrated as below.

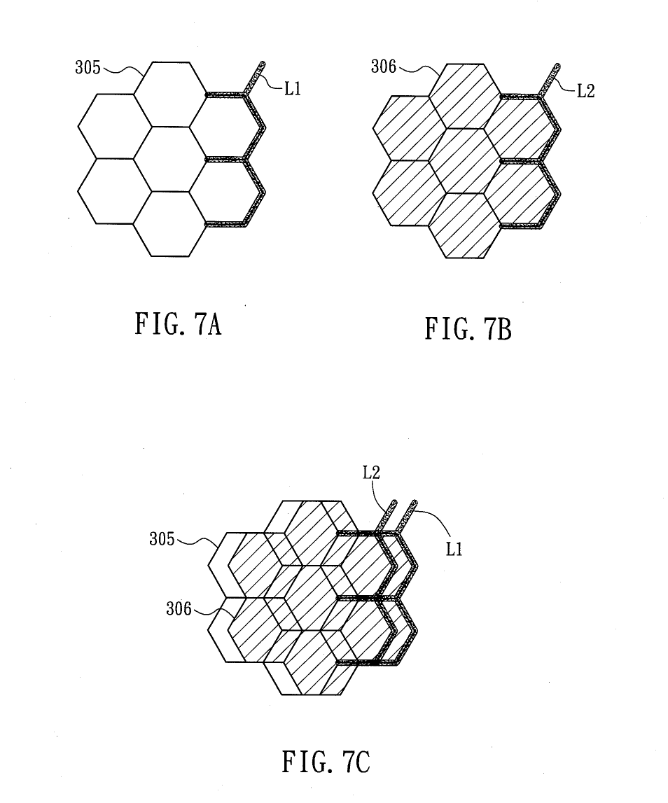

FIG. 7A is a schematic top view of the first conducting layer 305 of the dye sensitized solar cell of another embodiment of the invention, in which a plurality of dye portions (not shown) are disposed within the hexagons formed by the first conducting layer 305. FIG. 7B is a schematic diagram of the second conducting layer 306, which is formed into hexagons, of the dye sensitized solar cell of an embodiment of the invention, in which a plurality of catalytic layers (not shown) are respectively disposed within the hexagons formed by the second conducting layer 306. FIG. 7C is a schematic diagram of the first and second conducting layers 305 and 306 overlapped with each other.

Herein, the first conducting layer 305 is instanced as having seven hexagons, each of which is called a first electrode unit that is given a negative polarity for example. The second conducting layer 306 is instanced as having seven hexagons, each of which is called a second electrode unit that is given a positive polarity for example. A conducting wire L1 can be connected to the first electrode unit to draw out the electricity, and a conducting wire L2 can be connected to the second electrode unit to draw out the electricity. Besides, the portion (indicated by the thick lines in the figures) of the first conducting layer 305 connecting to the conducting wire L1 can have a larger width than other portions, and similarly, the portion (indicated by the thick lines in the figures) of the second conducting layer 306 connecting to the conducting wire L2 can have a larger width than other portions, thereby preventing the current crowding effect to enhance the electrical transmission efficiency. Further, the neighboring first electrode units and second electrode units can be formed to a series connection (the conducting wires L1 and L2 are connected with each other) or a parallel connection (the conducting wires L1 and the conducting wires L2 are connected with each other, respectively). The first electrode units or the second electrode units can be disposed in a single dye sensitized solar cell or in a plurality of the dye sensitized solar cells.

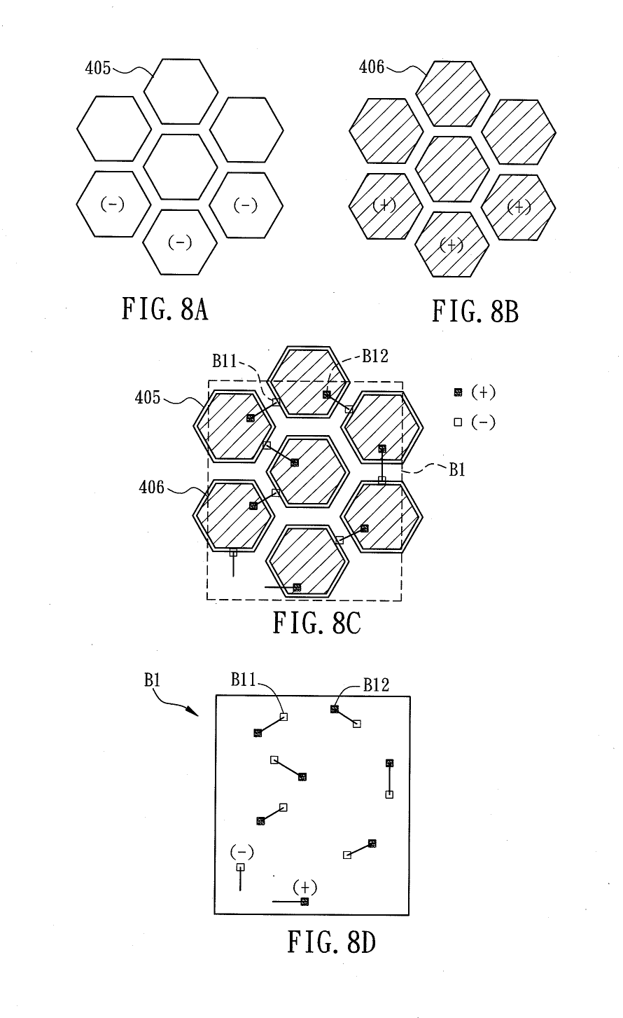

FIG. 8A is a schematic diagram of the first conducting layer 405, which is formed into hexagons, of the dye sensitized solar cell of another embodiment of the invention, in which a plurality of dye portions (not shown) are respectively disposed within the hexagons formed by the first conducting layer 405. FIG. 8B is a schematic diagram of the second conducting layer 406, which is formed into hexagons, of the dye sensitized solar cell of another embodiment of the invention, in which a plurality of catalytic layers (not shown) are respectively disposed within the hexagons formed by the second conducting layer 406. FIG. 8C is a schematic diagram of the first and second conducting layers 405 and 406 overlapped with each other.

Herein, the first conducting layer 405 is instanced as having seven hexagons, each of which is called a first electrode unit. The first electrode units are given negative polarities and not connected with each other, which means the hexagons are separated from each other. The second conducting layer 406 is instanced as having seven hexagons, each of which is called a second electrode unit. The second electrode units are given positive polarities and not connected with each other, which means the hexagons are separated from each other. The first and second electrode units are disposed in a single dye sensitized solar cell, and correspondingly overlapped with each other. Besides, the area of the second electrode unit is a little smaller than that of the first electrode unit.

FIG. 8D is a schematic diagram of a circuit board B1 used to electrically connect the first and second electrode units. The circuit board B1 can be disposed upon the second conducting substrate 202 as shown in FIG. 3 to electrically connect the first and second electrode units to make them a series connection. Herein, the second conducting substrate (not shown in FIG. 8C) can be composed of a plurality of stainless steel sheets, which are disposed corresponding to the hexagons respectively. The circuit board B1 has a plurality of first electrode pads B11 and a plurality of second electrode pads B12. When the circuit board B1 is disposed on the second conducting substrate, the first electrode pads B11 are electrically connected with the first electrode units, while the second electrode pads B12 are electrically connected with the second electrode units. FIG. 8C shows the locations of the first and second electrode pads B11 and B12 when the circuit board B1 is placed over the second conducting substrate. The first electrode pad B11 of the circuit board B1 is connected to the second electrode pad B12 of the neighboring hexagon through the conducting wire so that the first and second electrode units can be connected in series. Besides, the circuit board B1 can be a double-surface circuit board so that a surface of the circuit board B1 can be electrically connected with the first and second electrode units while the other one can be configured with a conducting circuit to connect an external circuit for transmitting the electricity outside.

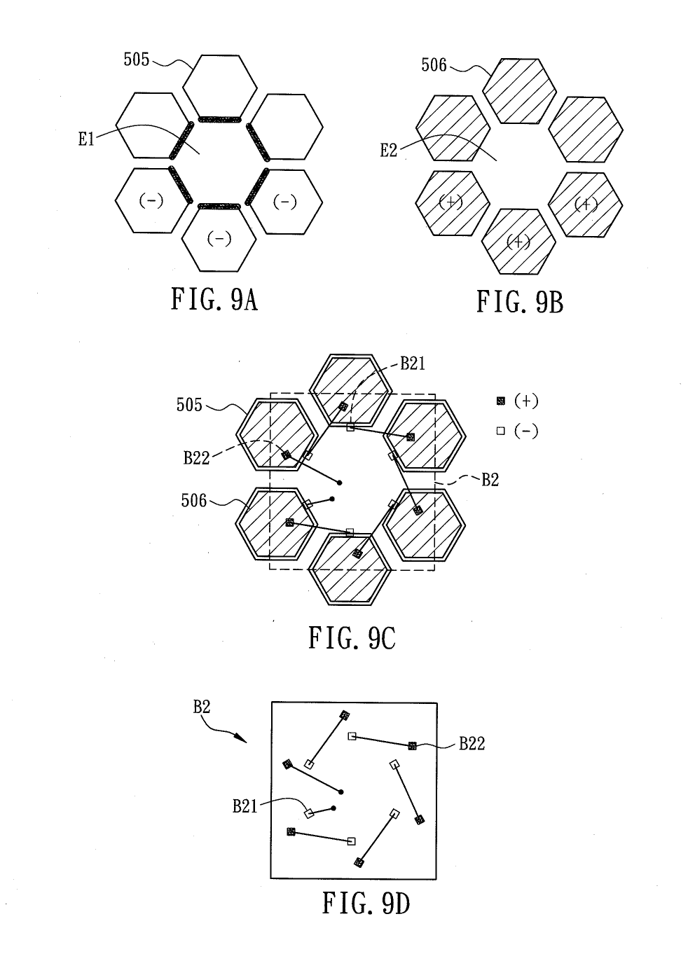

FIG. 9A is a schematic diagram of the first conducting layer 505, which is formed into hexagons, of the dye sensitized solar cell of another embodiment of the invention, in which a plurality of dye portions (not shown) are respectively disposed within the hexagons formed by the first conducting layer 505. FIG. 9B is a schematic diagram of the second conducting layer 506, which is formed into hexagons, of the dye sensitized solar cell of another embodiment of the invention, in which a plurality of catalytic layers (not shown) are respectively disposed within the hexagons formed by the second conducting layer 506. FIG. 9C is a schematic diagram of the first and second conducting layers 505 and 506 overlapped with each other.

Herein, the first conducting layer 505 is instanced as having six hexagons, each of which is called a first electrode unit. The first electrode units are given negative polarities and not connected with each other, which means the hexagons are separated from each other. Further, the first electrode units are disposed around a first empty area E1, the area without the first electrode unit. The second conducting layer 506 is instanced as having six hexagons, each of which is called a second electrode unit. The second electrode units are given positive polarities and not connected with each other, which means the hexagons are separated from each other. Further, the second electrode units are disposed around a second empty area E2, the area without the second electrode unit. The first and second electrode units are disposed in a single dye sensitized solar cell, and correspondingly overlapped with each other. Besides, the area of the second electrode unit is a little smaller than that of the first electrode unit.

FIG. 9D is a schematic diagram of a circuit board B2 used to electrically connect the first and second electrode units. The circuit board B2 can be disposed upon the second conducting substrate 202 as shown in FIG. 3 to electrically connect the first and second electrode units to make them a series connection. The circuit board B2 has at least one first electrode pad B21 and at least one second electrode pad B22. When the circuit board B2 is disposed on the second conducting substrate, the first electrode pads B21 are electrically connected with the first electrode units, and the second electrode pads B22 are electrically connected with the second electrode units. FIG. 9C shows the locations of the first and second electrode pads B21 and B22 when the circuit board B2 is placed over the second conducting substrate. The first electrode pads B21 and the second electrode pads B22 are connected through the conducting wires so that the first and second electrode units can be connected in series. Besides, the circuit board B2 can be a double-surface circuit board, a surface of which can be electrically connected with the first and second electrode units while the other one can be configured with a conducting circuit to connect an external circuit for transmitting the electricity outside. The circuit board B2 of the embodiment is disposed corresponding to the first and second empty areas E1 and E2 so as to provide convenient electrical connections. Besides, the portion (thick lines in FIG. 9A) of the first conducting layer 505 adjacent to the first empty area E1 can have a larger width than other portions, thereby enhancing the electrical transmission efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dye sensitized solar cell, comprising:
a first conducting substrate;
a dye layer having at least one dye portion and disposed on the first conducting substrate;
a first conducting layer disposed on the first conducting substrate and around the dye portion, and formed into at least one hexagon; and
a second conducting substrate disposed opposite to the first conducting substrate.

2. The dye sensitized solar cell as recited in claim 1, wherein the dye portion is formed into a hexagon.

3. The dye sensitized solar cell as recited in claim 1, wherein the first conducting layer has a plurality of hexagons.

4. The dye sensitized solar cell as recited in claim 2, wherein at least one hexagon formed by the first conducting layer has an area that is not less than the area of the hexagon formed by the dye portion.

5. The dye sensitized solar cell as recited in claim 1, wherein a distance between the first conducting layer and the dye portion is between 0.1 mm and 50 mm.

6. The dye sensitized solar cell as recited in claim 1, further comprising:
an insulating protective layer disposed on the first conducting layer.

7. The dye sensitized solar cell as recited in claim 6, wherein the material of the insulating protective layer includes glass paste.

8. The dye sensitized solar cell as recited in claim 1, wherein the material of the insulating protective layer includes bismuth oxide.

9. The dye sensitized solar cell as recited in claim 1, further comprising:
a second conducting layer disposed on the second conducting substrate.

10. The dye sensitized solar cell as recited in claim 1, wherein the line width of the first conducting layer or the second conducting layer is between 0.1 mm and 30 mm.

11. The dye sensitized solar cell as recited in claim 9, wherein the line width of the first conducting layer or the second conducting layer is between 0.1 mm and 30 mm.

12. The dye sensitized solar cell as recited in claim 9, wherein the first conducting layer and the second conducting layer are aligned with each other.
